(19) United States
(12) Patent Application Publication
(10) Pub. No.: US 2005/0078664 A1
(43) Pub. Date: Apr. 14, 2005

(54) Manipulation of transaction reports in a signaling network on an exchange of a network element

(76) Inventor: Gery Verwimp, Borgerhout (BE)

Correspondence Address: Siemens Corporation;Intellectual Property Department, 170 Wood Avenue South, Iselin, NJ, 08830, US

(21) Appl. No.: 10/500,412

(22) PCT Filed: Mar. 17, 2003
(86) PCT No.: PCT/DE03/00855

(30) Foreign Application Priority Data
Mar. 20, 2002 (DE) 102 12 375.6

(51) Int. Cl. H04L 12/50

(52) U.S. Cl. 370/357

(57) ABSTRACT

Transaction reports in a signaling network comprise, amongst other things, identification codes, which characterize the network elements concerned and identification numbers for the reports. On exchange of a network element, conventionally, a transition phase is used with simultaneous operation of a network element for replacement and the replacing network element. During said phase problems occur with relation to the unambiguity with the generation of identification numbers as both network elements concerned are operated in said phase with the same identification code. The problem particularly arises due to the fact that the generation of identification numbers in network elements is not standardized. According to the invention, all transaction messages are run through the replacing network element during the simultaneous operation phase, the identification numbers thereof are registered and optionally altered in order to achieve unambiguous relationships between the transaction numbers and the transaction messages.

### CROSS REFERENCE TO RELATED APPLICATIONS

This application is the US National Stage of International Application No. PCT/DE03/00855, filed Mar. 17, 2003 and claims the benefit thereof. The International Application claims the benefits of German Patent application No. 10212375.6 DE filed Mar. 20, 2002, both of the applications are incorporated by reference herein in their entirety.

### SUMMARY OF INVENTION

The invention relates to the area of message transfer between network elements of a signaling network in the case of the exchange of a network element, for example of a router or a switch. It examines the case in which the network elements use identification codes during the transfer of transaction reports to initiate functions in another network element.

### BACKGROUND OF INVENTION

The following description relates to the case in which the SS#7 protocol family is used for controlling the exchange of information in the signaling network. However the invention encompasses in a similar way all applications in which other protocols with corresponding characteristics are used.

One of the parts included in SS#7 is the part used for data communication and referred to as the ‘Message Transfer Part’ (MTP). A further part is used for initiation of functions in another network element and is referred to as the ‘Transaction Capabilities Application Part’ (TCAP). Typically the TCAP is used to access remote routing databases and to coordinate IN services in intelligent networks across a number of exchanges. Reports which relate to the TCAP are referred to as transaction reports in this document.

For network elements of a signaling network this can for example involve Signal Transfer Points' (STP) which function as routers or switches. To exchange transaction reports with each other they use a separate code which characterizes the network element and is usually referred to as the ‘Signaling Point Code’ (SPC).

As well as the SPCs of the network elements involved, transaction reports of network elements usually contain as a transaction code a number for the identification of the transaction, referred to below as the Transaction Identification Number (TID). This is generated in a network element using a method which is generally individually designed for each network element. However the range of numbers available for issuing the TIDs is typically uniform in a number of network elements.

When a network element is exchanged there are basically two options with regard to manipulation of the SPCs: Either the exchange network element is given the same SPC as the network element to be exchanged or it is given a different SPC. If a different SPC is selected considerable effort is involved since changes must then be made to the databases in further network elements. To this extent it is worth trying to ensure as much as possible that the same SPC is used on the exchange network element as on the network element to be exchanged.

On exchange of a network element there is usually a phase in time during which the network element to be exchanged and the exchange network element are operated simultaneously. If—as described—the SPC is to be retained for the exchange there can be resulting difficulties in this simultaneous operating phase as regards manipulation of the TIDs, since both the network elements concerned generate TIDs independently.

Usually it is not possible on two network elements to restrict the two corresponding ranges of numbers from which the TIDs are allocated such that they are mutually exclusive, since the process of generating TIDs, as mentioned above, is not standardized and as a result depends on the individual implementation on a network element. Thus the problem of generating a unique SPC/TID combination for transaction reports arises.

### SUMMARY OF INVENTION

The object of the invention is to make it possible in a signaling network with at least two of its network elements which have an identical code, to uniquely assign transaction reports from the signaling network.

This object is achieved by the method specified in Patent Claim 1. Advantageous embodiments of the invention are specified in the subclaims.

The invention is illustrated below first of all for the case of at least two network elements, an element to be exchanged and an exchange network element.

In accordance with the invention all transaction reports are routed between the network element to be exchanged and the signaling network via the exchange network element. In this way the exchange network element operates as a forwarding station for the transaction reports concerned.

If a transaction report enters an exchange network element from the signaling network, an initial check is made by the exchange network element as to whether this report is intended for the exchange network element itself of for the network element to be exchanged. If the transaction report is intended for the network element to be exchanged, it is labeled by the exchange network element with the network element to be exchanged as its intended destination and returned to the MTP of the signaling network. The ‘Signaling Connection Control Part’ (SCCP) of SS#7 is used for this. This report can then finally be processed in the network element to be exchanged.

In the exchange network element, after arrival of a transaction report which is transferred by the network element to be exchanged or is intended for the latter, the TID of this transaction report is registered. With the information obtained from this TID it is easily possible in the exchange network element to exclude ambiguities when generating further TIDs.

In particular it may be necessary here for a transaction report to be provided with a new TID. in such a case a transaction report thus has a different TID on entry into the exchange network element than it has when leaving the exchange network element.

If at least two network elements are to be replaced by one exchange network element, all transaction reports between the network element to be exchanged and the signaling network are routed via the exchange network element. On entry of a transaction report for a network element to be exchanged from the signaling network at the exchange network element an initial check is made in this case as to which of the network elements to be exchanged is the intended destination of the transaction report. The procedure is then as detailed above after selection of precisely this network element as the network element to be exchanged.

The case in which one of a number network elements to be exchanged transmits a transaction report via the exchange network element to the signaling network is completely the same as the case with two network elements.

### BRIEF DESCRIPTION OF THE DRAWINGS

Further features, advantages and characteristics will now be explained on the basis of a more detailed description of an exemplary embodiment and with reference to the Figures depicted in the enclosed drawings. The drawings show

FIG. 1 the path of a transaction report from a signaling network to a network element to be exchanged during the simultaneous operating phase with an exchange network element;

FIG. 2 shows the path of a transaction report from a network element to be exchanged to a signaling network to during the simultaneous operating phase with an exchange network element;

FIG. 3 shows components of a network element which are of importance for the path of a transaction report from a network element to be exchanged to a signaling network;

FIG. 4 shows components of a network element which are of importance for the path of a transaction report from a signaling network to a network element to be exchanged;

FIG. 5 shows the further processing in the coordination processor of the Call Feature Server after the destination address is requested.

### DETAILED DESCRIPTION OF INVENTION

In a SS#7 signaling network each network element has a unique Signaling Point Code. The network elements use these codes when exchanging signaling messages with one another.

Transaction reports are typically used for accessing remote databases and coordinating IN services in intelligent networks across a number of exchanges. In the case of SS#7 the corresponding protocol part is called the ‘Transaction Capabilities Application Part’ (TACP) and the corresponding reports are referred to as TCAP reports.

If TCAP reports are exchanged between the network elements, the reports between the network elements involved contain not only the Signaling Point Codes of the communication partners, but also what are known as Transaction Identification Numbers (TID). Each network element issues its TIDs in accordance with its own scheme and, in doing so, uses the same range of numbers as the other network elements.

If a network element (for example an exchange which supports SS#7 signaling) is to be replaced by a new network element, the normal procedure is as follows: A new Signaling Point Code is assigned to the new network element and the two network elements are operated in parallel until the complete functionality (for example subscribers of a exchange) has passed from the old network element to the new one. If different Signaling Point Codes are used in this case this leads to significant effort since administrative changes may have to be made in SS#7 databases of very many elements in the SS#7 network.

To reduce this effort to a minimum it is necessary to allocate the same Signaling Point Code to both network elements, the old and the new. This however requires a special procedure with regard to the signaling point codes which are generated independently on the two network elements with the same Signaling Point Code. Usually it is not possible to restrict the use of TIDs by the two network elements to separate ranges of numbers since the generation process for TIDs is not standardized and as a result depends on the implementation. Thus there must be some way of ensuring that unique combinations of Signaling Point Code and TID are used in the SS#7 network.

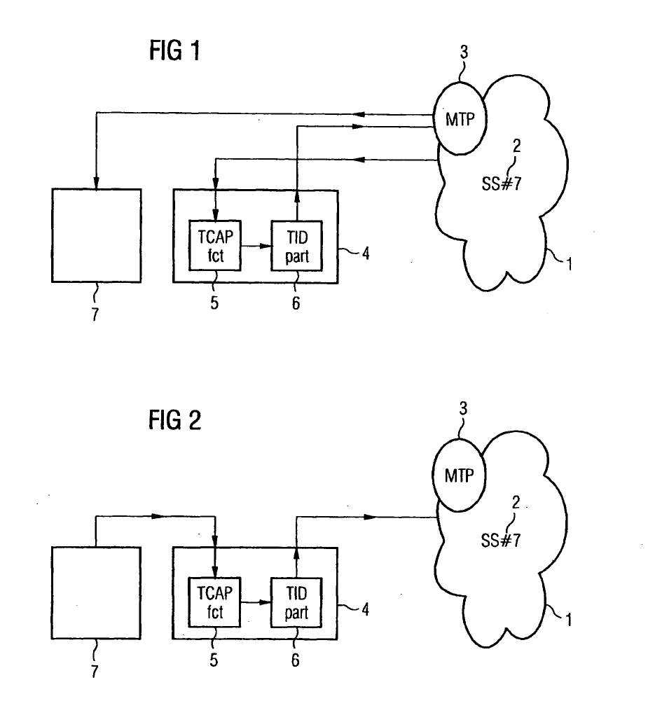

In the case of the examples shown schematically in FIGS. 1 and 2 SS#7 2 will be used as the SS#7 protocol family for signaling network 1. The ‘Message Transfer Part’ (MTP) 3 represents that part of the SS#7 protocol family 2 which regulates data communication.

The requirement is for the exchange network element (the new network element) and the network element to be exchanged (the old network element) to have an identical Signaling Point Code (SPC).

FIG. 1 shows paths—represented schematically by arrows—of a transaction report during the phase in which an exchange network element—shown in the example in the form of a ‘Signaling Switching Point’ (SSP) 4—and a further network element which is to be replaced by the exchange network element are to be operated simultaneously. The exchange network element 4 includes a TCAP function 5, a processing unit for transaction reports and a TID part 6 in which the TIDs are administered.

FIG. 1 shows the path of a transaction report which is directed from the signaling network 1 to the network element to be exchanged 7 In accordance with the invention this report is first sent to the exchange network element 4 which is connected between the signaling network and the network element to be exchanged. Arriving there, the report is directed to the TCAP function 5. This determines that the report is intended for the network element to be exchanged 7.

The report is then forwarded to the TID part 6 in which the TID of this report is registered. In the subsequent process the report is sent back to the MTP 3 of the signaling network 1. The part of SS#7 known as the ‘Signaling Connection Control Part’ (SCCP) which is used to expand the addressing and the translation of valid global IP addresses into locally valid network addresses handles this operation.

From there the report then finally arrives at its intended destination, the network element to be exchanged 7. The information about the TID of this report is thus available in the exchange network element 1 and can be taken into account for generation of further TIDs.

FIG. 2 shows the path of a transaction report which is intended to be sent from the network element to be exchanged 7 for the signaling network 1. In accordance with the invention this report is first sent to the exchange network element 4. Arriving there, the report is directed to the TCAP function 5. This determines that the report is intended in this case for the signaling network 1. The report is then forwarded to the TID part 6.

In the TID part 6, on the basis of the available information about the TIDs already used, a check is made as to whether retaining the TID (the current transaction report) could lead to ambiguities later on in the process. In this case the TID will be changed so that it can be uniquely assigned to the transaction report within the subsequent process. Otherwise the TID can be retained unchanged. From the TID part 6 the report finally reaches its intended destination, the signaling network 1.

Again the information about the—if necessary new—TID of the transaction report is available in the exchange network element 1 and can be taken into account for generation of further TIDs.

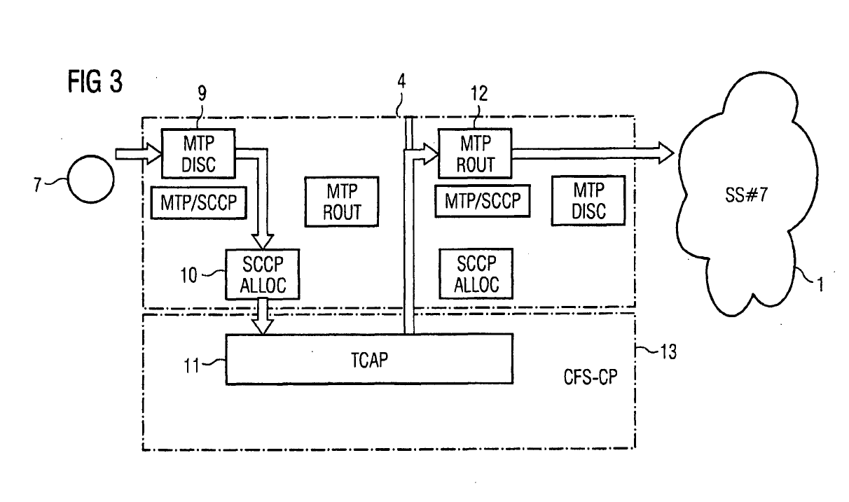

FIG. 3 shows a schematic diagram of the components of a network element 4 which have a role to play in the transfer of transaction reports from a network element to be exchanged 7 to the signaling network 1. An incoming report is forwarded by the MTP DISC element 9 to the SCCP ALLOC element 10. In this element the SPC of the intended network element (Global Title Translation, GTT) is usually determined using the information on the global address contained in the report. In the special case discussed here of the report which originates from the network element to be exchanged 7, this is not done however.

The report is forwarded into the coordination processor of the ‘Call Feature Server 13, in which the TCAP application 11 is realized. Here in particular the TID of the report is registered and where necessary changed to uniquely assign the TID. The issued TID is thus available at network element 4 and can then be taken into consideration. From there the report passes via the MTP ROUT element 12 to finally arrive at the signaling network 14.

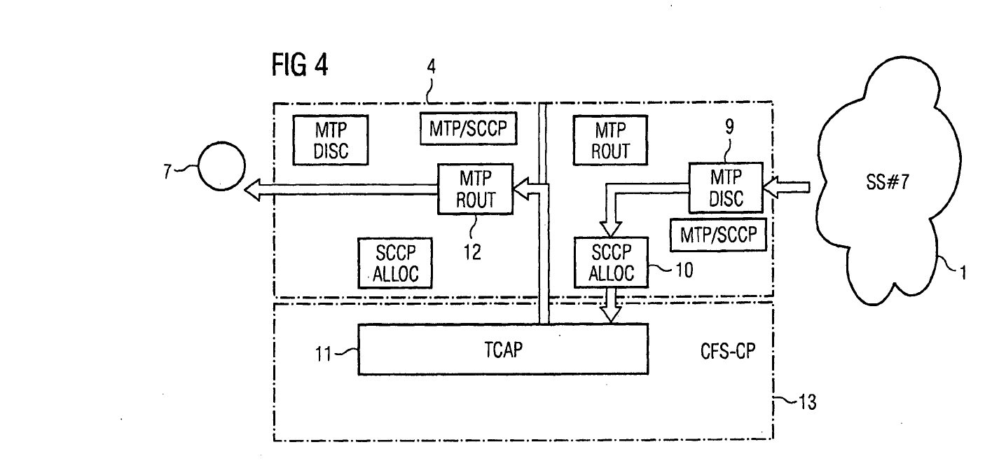

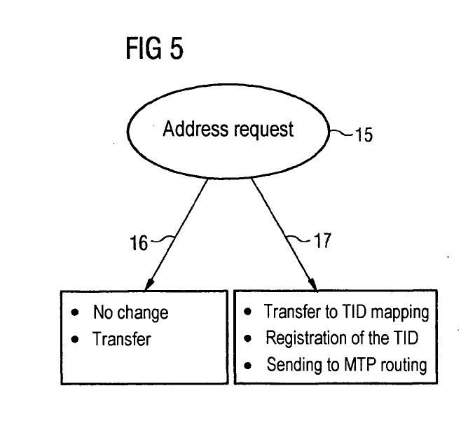

FIG. 4 shows a schematic diagram of the components of a network element 4 which have a role to play in the transfer of transaction reports from the signaling network 1 to a network element to be exchanged 7. An incoming report is forwarded by the MTP DISC element 9 to the SCCP ALLOC element 10. Here the fact that the intended network element is the network element 8 to be replaced is registered. The report is forwarded into the coordination processor of the Call Feature Server 13, in which the TCAP application 11 is realized. In this server the TID of report is registered in particular so that from then on it can be taken into consideration at the network element 4. From there the report passes via the MTP ROUT element 12 to finally arrive at the network element to be exchanged 7.

FIG. 5 shows the further processing of a transaction report after the destination address request 15 for this report in the coordination processor of a network element to be exchanged. If the report is intended for the exchange network element itself 16, this does not change the current process. The report is forwarded to the interface of the network element with the connecting lines to further network elements. In this case it should not be the network element to be exchanged since this would indicate an error.

If the report is intended for the network element 17 to be replaced, the TID of the report is first registered, before the report is finally forwarded via MTP to the network element to be replaced.

The sequence in accordance with the invention can thus be summarized as follows:

The initial situation is dictated by the fact that both the old and the new SS#7 network element use the same Signaling Point Code and that in general it is not possible to restrict the old network element to a restricted range of TID numbers which is separate from the range of TID numbers which is used on the new network element.

In accordance with the proposed solution all transaction reports are routed between the old network element and the SS#7 network by the new network element. This means that the new network element performs a forwarding function for these reports.

The SS#7 protocol defines that SS#7 reports received which are directed to the own Signaling Point Code are to be transferred to the corresponding application which is defined by the information in the header of the report. The idea is: Instead of the report being directed to the receiving TCAP application part, it is first determined in the TCAP function in the new network element whether the TCAP report is actually intended for the local TCAP function or whether the recipient is to be found on the old network element with the same Signaling Point Code. In the latter case the TCAP function returns this report via SCCP to the MTP function so that it can be forwarded from there to the old network element, where it will finally be processed.

In the new network element the TIDs within the TCAP report are always recorded when these reports originate from the old network element or are intended for this element. In this way possible TID ambiguities are resolved and the reports are delivered correctly to the TCAP application parts on the old network element and on the new network element.

1-7. (canceled)

8. A method for exchanging a network element in a signaling network, comprising:
directing all transaction reports between the network element to be exchanged and the signaling network via the exchange network element, the exchange network element and the network element to be exchanged using the same identifying code;
determining whether a transaction report arriving from the signaling network is intended for the network element to be exchanged or the exchange network element itself and is decided by the network element to be exchanged; and
forwarding the transaction report to the network element to be exchanged for further processing and otherwise further processing in the exchange network element depending on the decision in the network element to be exchanged.

9. The method in accordance with claim 8, wherein the network elements, on transmission of transaction reports for initiation of functions in another network element transmit an identification code identifying the sending network and transmit a transaction code.

10. The method in accordance with claim 8, wherein the transaction code of a transaction code report is registered in the network element.

11. The method in accordance with claim 8, wherein the transaction code of a transaction code report is changed in the network element.

12. The method in accordance with claim 8, wherein a transaction code which can uniquely identify the transaction report is issued by a network element for a transaction report.

13. The method in accordance with claim 10, wherein a transaction code which can uniquely identify the transaction report is issued by a network element for a transaction report.

14. The method in accordance with claim 11, wherein a transaction code which can uniquely identify the transaction report is issued by a network element for a transaction report.

15. The method in accordance with claim 8, wherein SS#7 is used as the signaling protocol.

16. The method in accordance with claim 8, wherein the part of the signaling protocol used is the part for processing addresses when forwarding a transaction report.

17. The method in accordance with claim 8, wherein one of the network elements is specified as a Signaling Transfer Point.
